(19) United States
(12) Patent Application Publication
(10) Pub. No.: US 2004/0098591 A1
(43) Pub. Date: May 20, 2004

(54) Secure hardware device authentication method

(76) Inventor: James W. Fahrny, Thornton, CO (US)

Correspondence Address: PATTON BOGGS, 1660 LINCOLN ST, SUITE 2050, DENVER, CO, 80264, US

(21) Appl. No.: 10/295,182

(22) Filed: Nov. 15, 2002

(51) Int. Cl. H04L 9/00

(52) U.S. Cl. 713/176

(57) ABSTRACT

The present secure hardware device authentication method further protects the data within the secure hardware device by authenticating the trusted software object prior to allowing the trusted software object to access protected data within the secure hardware device. Authenticating the trusted operating system prior to granting access to the secure hardware device prevents an unauthorized individual from tampering with the trusted software object after the computer system is initialized. The method of authentication may include authentication of the certificate appended to the trusted software object or may be a request for a signed message from the trusted software object. If the trusted software object is not authenticated, access to the secure hardware device is denied.

### FIELD OF THE INVENTION

The present invention relates to computer systems and in particular, to a method for authenticating a software object to authorize the software object to access protected data within secure hardware device.

### PROBLEM

It is a problem in the field of secure hardware to prevent unauthorized access to the protected area of the secure hardware device through a trusted operating system that has been tampered with during operation. The computer system containing the secure hardware is often installed with a trusted operating system, also referred to as a “kernel” or a “trusted OS”. Trusted operating systems provide the basic security mechanisms and services that allow a computer system to protect, distinguish, and separate classified data. When the system is initialized, the trusted operating system is authenticated, thereafter, the operating system is trusted during operation and may access the protected area of the secured hardware device. A first problem arises during operation of the computer system containing the secure hardware. Since the operating system is trusted, the operating system may be tampered with during operation and allow an unauthorized individual to gain access to the secure hardware device without being detected. A second problem is that the computer system is limited to operation with the trusted operating system, which prevents the computer system owner from installing an off-the-shelf operating system on the computer system.

Authenticating the identification of an individual is typically performed using pieces of information that are unique to the individual such as an address, telephone number, social security number, or a physical characteristic such as a fingerprint. When accessing secure data, a computer system may require a unique identification assigned to the individual such as a USER ID in combination with a password or an account number in combination with a PIN. Likewise, hardware and software components may be assigned an identification that is unique to the hardware, the software or the owner of the hardware and/or software. Authentication of the trusted operating system relies on cryptography.

Cryptography has become one of the main tools for privacy, trust, access control, electronic payments, corporate security, and countless other fields. Cryptography can be used to achieve authenticity, which means that the message came from the intended source and has not been altered in transit. When a secret key is used, in combination with the content of the message, to construct a value that the recipient can check, then cryptography achieves authentication. Cryptography is central to modern information security because it can provide either confidentiality or authenticity, and it can also combine them in useful ways.

Software objects are typically authenticated using digital signatures, a certificate or a key exchange which identifies the hardware device or software object. Digital signatures are used to verify that a message really comes from the claimed sender. Digital signatures can also be used to authenticate that a public key belongs to a particular person. This is done by signing the combination of the key with information about its owner by a trusted key (digital signature of a third party which owns the trusted key). The public key and information about the owner of the public key are often called certificates.

A digital signature of an arbitrary document is typically created by computing a message digest from the document or software object, and concatenating it with information about the signer. The resulting string is then encrypted using the private key of the signer using a suitable encryption algorithm. The resulting block of bits is the signature. The signature is often distributed with information about the public key that was used to sign it. The process just described is referred to as code signing. To verify the signature, the recipient decrypts the signature using the public key of the person. If the signatures decrypts properly and the information matches the message (or message digest), the signature is accepted as authenticated.

When the system embodying the secure hardware device is initialized, the secure hardware device authenticates the software operating on the system. After the software has been authenticated, the software is “trusted” during operation and is granted access to the protected data within the secure hardware. However, a problem arises when the trusted software object executed on the computer system is tampered with during operation by an unauthorized individual. Once the trusted software object has been authenticated, the software object is not later authenticated when access to the protected data within the secure hardware is requested. Since the trusted software object is not authenticated during runtime when requesting access to the secure hardware device, the computer system may allow access by a trusted software object that has been tampered with and is therefore no longer secure. This lack of security provides a method for unauthorized individuals to alter the operation of the computer system. Since many computer systems embodying secure hardware devices may store features, or critical operation data, within the secure hardware device, an unauthorized individual may alter the operation of the computer system.

The second problem is executing a commercial software object on the protected computer system. Since the protected computer system includes a trusted software object that can be authenticated by the secure hardware device within the protected computer system, installing a commercial software object results in a software object that is denied access to the protected data within the secure hardware device since the secure hardware device is unable to authenticate the commercial software object. The problem limits the software objects that are available to the protected computer system owner and may even limit the source of the software object that can be authenticated. Limiting the selection and the source of the software object which may be executed on the protected computer system results in increased cost to the protected computer system owner.

For these reasons, a need exists for a method for authenticating a commercial software object and authenticating the trusted or commercial software object each time the trusted or commercial software object requests access to the protected data within the secure hardware device.

### Solution

The present secure hardware device authentication method further protects the data within the secure hardware device by authenticating the trusted software object prior to allowing the trusted software object to access protected data within the secure hardware device. Authenticating the trusted operating system prior to granting access to the secure hardware device prevents an unauthorized individual from tampering with the trusted software object after the computer system is initialized. The method of authentication may include authentication of the certificate appended to the trusted software object or may be a request for a signed message from the trusted software object. If the trusted software object is not authenticated, access to the secure hardware device is denied.

In an alternative embodiment, a commercially available software object may be installed in the computer system embodying the secure hardware device. The digital certificate used to authenticate the software object is appended to the binary code image of the commercial software object and the entire package, certificate and commercial software object, is signed. When the computer system is executing a commercial software object, the secure hardware device authenticates the certificate and the combination of the commercial software object and appended certificate. If both are authenticated, access is granted.

In another embodiment, the authentication is tiered. When the trusted software object requests access to the secure hardware device the certificate appended to the trusted software object is authenticated. If the trusted software object requests permission to change protected data within the secure hardware device, the secure hardware device may request a signed message from the trusted software object prior to granting the trusted software object permission to change the protected data. This access to the data within the secure hardware device may require a lower level of security then a request to change the protected data within the secure hardware device.

Another alternative is to have the secure hardware device perform a Diffie-Hellman key exchange with the software object using a predefined shared secret. If the software object contains the secret, the access to change the protected data is granted. These methods have varying levels of assurance and can even be used in combination for higher assurance.

### BRIEF DESCRIPTION OF THE DRAWINGS

FIG. 1 illustrates a block schematic diagram of a sample computer system embodying the present secure hardware device authentication method;

FIG. 2 illustrates a flow diagram of an embodiment of the present secure hardware device authentication method;

FIG. 3 illustrates a flow diagram of the present secure hardware device authentication method;

FIG. 4 illustrates a flow diagram of additional steps for the flow diagram of FIG. 2 to provide an additional level of security; and

FIG. 5 illustrates a flow diagram of the usage of the present secure hardware device authentication method for providing tiered authentication.

### DETAILED DESCRIPTION

The present secure hardware device authentication method summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

Computer systems used for processing and storing confidential or classified data often include hardware and software security features. Secure hardware may be used to store the confidential data or to gain access to the secure memory. Computer systems including embedded secure hardware may include a secure, or trusted software object. The trusted software object provides the basic security mechanisms and services that allow the computer system to protect, distinguish, and separate the confidential data. Thus, the trusted software object lowers the risk of implementing a system that processes confidential data.

The trusted software object is authenticated when the protected computer system is initialized, and is thereafter trusted. Authentication of the trusted software object relies on cryptography. The secure hardware includes an encryption algorithm and an encryption key for use in authenticating the trusted software object to ensure that the trusted software object has not been tampered with prior to initialization of the protected computer system. Once the trusted software object is authenticated, the trusted software object may access the secure hardware to load confidential data, or to change the encryption algorithm and encryption key used to authenticate the trusted software object. Prior to loading confidential data or changing the authentication process the trusted operating system is not challenged. Instead, an operating system is trusted because the operating system was authenticated at initialization.

Cryptography has become one of the main tools for privacy, trust, access control, electronic payments, corporate security, and countless other fields. Cryptography can be used to achieve authenticity, which means that the message came from the intended source and has not been altered in transit. When a secret key is used, in combination with the content of the message, to construct a value that the recipient can check, then cryptography achieves authentication. Cryptography is central to modern information security because it can provide either confidentiality or authenticity, and it can also combine them in useful ways.

Digital signatures are used to verify that a message really comes from the claimed sender. Digital signatures can also be used to authenticate that a public key belongs to a particular person. This is done by signing the combination of the key with information about its owner by a trusted key (digital signature of a third party which owns the trusted key). The public key and information about the owner of the public key are often called certificates.

A digital signature of an arbitrary document is typically created by computing a message digest from the document or software object, and concatenating it with information about the signer. The resulting string is then encrypted using the private key of the signer using a suitable encryption algorithm. The resulting block of bits is the signature. The signature is often distributed with information about the public key that was used to sign it. To verify the signature, the recipient decrypts the signature using the public key of the person. If the signature decrypts properly and the information matches the message (or message digest), the signature is accepted as authenticated.

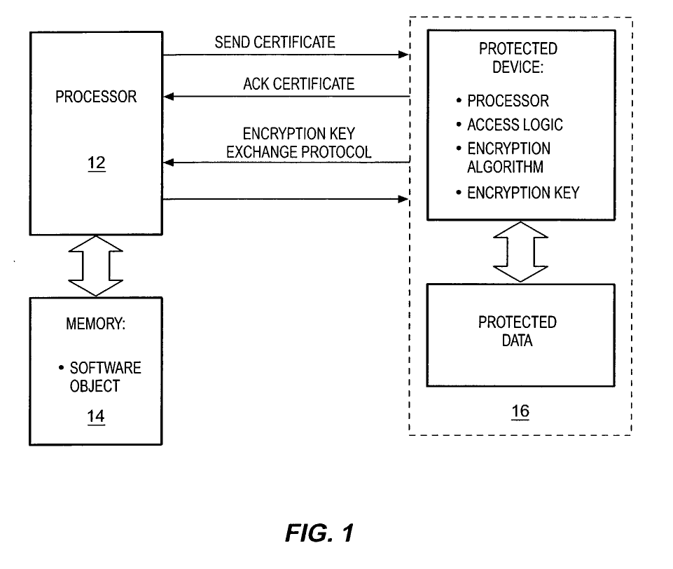

Protected Computer System—FIG. 1:

Referring to the block schematic diagram of FIG. 1, a sample computer system embodying the present secure hardware device authentication method may include a memory 14 for storing software objects such as a trusted operating system and a processor 12 for executing the software objects in accordance with the following description. The computer system also includes a protected hardware device 16 for storing protected data. The protected data may be confidential email, confidential data, or registers that contain confidential data that is critical to the operation of the computer system, or any other form of data that requires protection. For purpose of illustration, and not limitation, the confidential data is described as protected data that is passed between the processor 12 and the secure hardware device 16.

Secure hardware devices are commercially available and may include a processor and internal memory for storing an encryption algorithm and an encryption key for use authenticating the software object running on the computer system or authenticating the hardware which is executing the software object. The secure hardware device may also include internal logic which is be enabled after the hardware and or software object requesting access to the secure hardware device is authenticated. Once the access logic has been enabled, the internal memory and/or registers storing the protected data may be accessed to exchange data or to change the encryption algorithm and/or the encryption key used for authentication.

In a typical computer system embodying a secure hardware device and executing a trusted software object, once the trusted software object is authenticated when the computer system is initialized, the trusted operating system thereafter has access to the secure hardware device and the protected data contained therein. However, the trusted software object may be tampered with after initialization and thereafter be insecure. Providing access to an insecure (formerly trusted) software object allows an unauthorized individual to access the protected data, to change the encryption algorithm used for authentication or to change the encryption key used in conjunction with the encryption algorithm.

In an alternative embodiment, a commercially available software object may be installed on the protected computer system embodying the secure hardware device in step 100. The digital certificate used to authenticate the commercial software object is appended to the binary code image of the commercial software object in step 104 and the entire package, certificate and commercial software object, is signed in step 106. Prior to appending the certificate, the certificate is signed in step 102 by the commercial software object.

Providing a method for authenticating an off-the-shelf commercially available software object allows the protected computer system owner to select the software object executing on the protected computer system. Once authenticated, the commercial software object has access to the protected data within the secure hardware device.

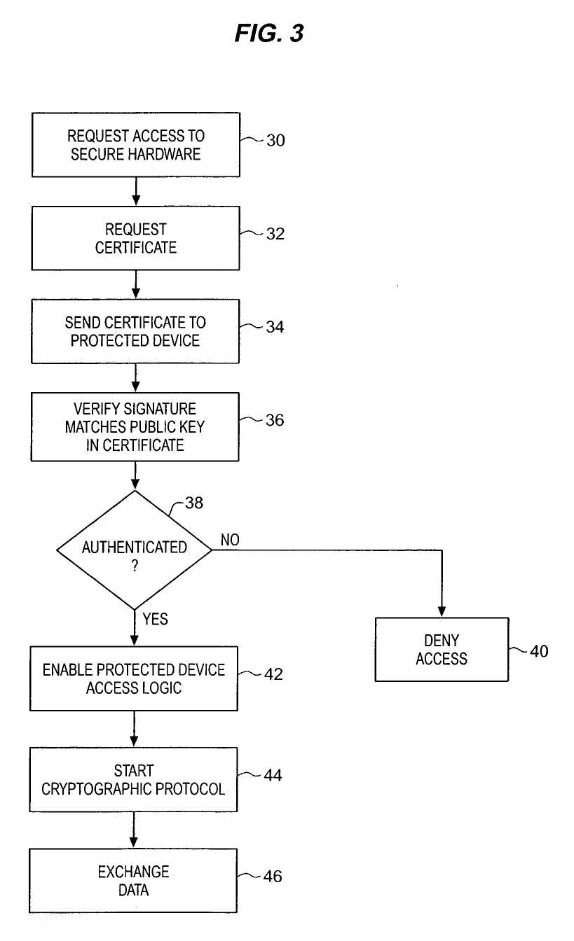

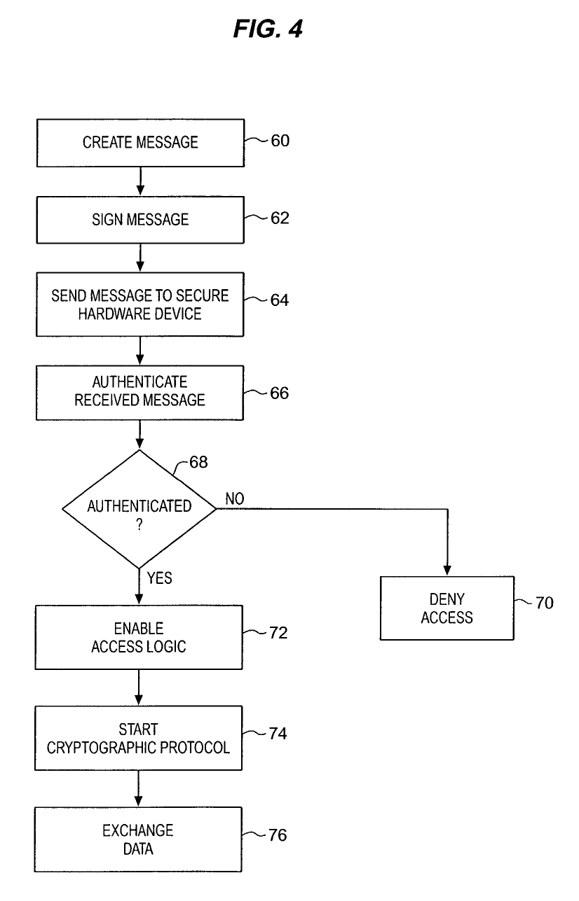

Secure Hardware Device Access—FIGS. 3 and 4:

Typically, the secure hardware device authenticates the software object installed in the computer system when the computer system is initialized, which implicitly established a level of trust of the hardware on which the software object is executed. Thereafter, the secure hardware device may request further authentication when the software object requests access to the protected data or the authentication process within the secure hardware device.

The present secure hardware device authentication method enables the secure hardware device to detect when a trusted software object has been tampered with during operation and to deny access to protected data within the secure hardware device. Referring to the flow diagram of FIG. 3, when a software object that has previously been authenticated requests access to the secure hardware device in step 30, traditionally, the access is granted. To provide an extra level of security, the secure hardware device requests a certificate in step 32 from the software object requesting access. In step 34, the software object sends the requested certificate to the secure hardware device where the secure hardware device authenticates the certificate in step 36 using the public key in the certificate. If the signature is not authenticated in step 38, access to the secure hardware device is denied in step 40.

Once the certificate is authenticated in step 38, the secure hardware device enables/internal access logic in step 42 and the secure hardware device and the software object start a previously agreed upon cryptographic protocol in step 44 for use exchanging data in step 46. The cryptographic protocol may be an RSA, a Diffie-Hellman key exchange or any other cryptographic protocol appropriate for the data being protected. For example, using the Diffie-Hellman key exchange, the secure hardware device performs a Diffie-Hellman key exchange with the software object using a predefined shared secret. If the software object contains the secret, the access to change the protected data is granted. These methods have varying levels of assurance and can even be used in combination for higher assurance.

Authenticating the software object requesting access to the secure hardware device when the software object requests access after initialization provides another level of security to prevent unauthorized individuals from accessing protected data. However, since a certificate may be attached to an insecure software object, in another embodiment, another level of security is added.

Referring to the flow diagram of FIG. 4, in this embodiment the secure hardware device may request that the software object send a signed message in step 64 to the secure hardware device. In step 60, the software object creates a message as a message digest from the software object, and then signs the message in step 62. The signed message is sent to the secure hardware device in step 64 with information about the public key that was used to sign it. Once received, the secure hardware device authenticates the received message in step 66 using the public key in the certificate. To verify the signature, the secure hardware device decrypts the signature using the public key of the software object. If the software object has been tampered with, the message digest used to create the signature would not properly decrypt at the secure hardware device and access to the secure hardware device is denied in step 70.

If the signature decrypts properly and the information matches the message (or message digest), the signature is accepted as authenticated. If the message is authenticated in step 68, the secure hardware device enables internal access logic in step 72 and the secure hardware device and the software object start a previous agreed upon cryptographic protocol in step 74 for use exchanging data in step 76. The cryptographic protocol may be an RSA, a Diffie-Hellman key exchange or any other cryptographic protocol appropriate for the data being protected. The authenticated software object now exchanges reads and writes data from and to the secure hardware device in step 76 through a secure encrypted channel by using the encryption keys that were exchanged as a part of the cryptographic protocol started in step 74.

Further authenticating the software object requesting access to the secure hardware device when the software object requests access to the secure hardware device provides another level of security to prevent unauthorized individuals from tampering with the software object after the computer system has been initialized. If the software object has been tampered with, the message digest used to create the signature would not properly decrypt at the secure hardware device and access to the secure hardware device would be denied in step 70. The additional step ensures that the software object to which the software object is attached has permission to use the certificate for authentication.

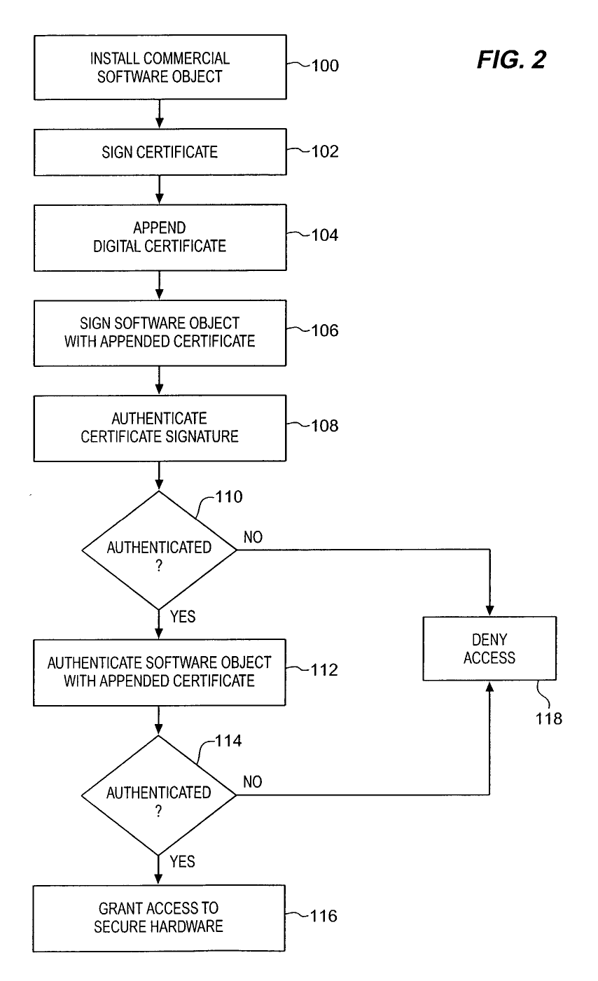

When the software object being authenticated is a commercial software object, the authentication process requires two authentications. Referring back to FIG. 2, the certificate is first authenticated in step 108, and if the certificate is authenticated in step 110, the combined commercial software object and appended certificate is authenticated in step 112. The key used by the secure hardware device to authenticate the signatures in steps 108 and 112 is found in the certificate. Access to the secure hardware device is granted in step 116 if the combined commercial software object and appended certificate is authenticated in step 114. If the authentication fails in step 110 or in step 114, access to the secure hardware device is denied in step 118.

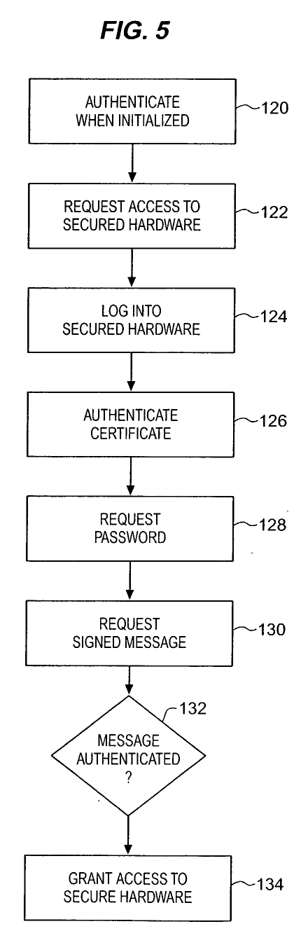

Tiered Authentication—FIG. 5:

The present secure hardware device authentication method may provide tiered authentication. Referring to the flow diagram of FIG. 5, when the computer system is initiated the software object may be authenticated in step 120 using a certificate attached to the software object or may include authentication using a message digest of the software object. During operation, the computer system may require authentication of the software object using a certificate when the software object requests access to the secure hardware device in step 122. The tiered authentication, which provides an additional level of security, may be implemented when the software object requests to change the configuration of the secure hardware device by changing the encryption algorithm or encryption key used to authenticate the software object. The secure hardware device advances from state to state to change the configuration of the secure hardware device. In this embodiment, the present secure hardware device authentication method may prevent the secure hardware device from advancing to the next crypto state without further authentication of the software object. Requiring authentication prior to advancing from one state to a next state prevents the secure hardware device from completing all of the states without passing each level of security.

For example, before allowing a software object that was authenticated in step 120 to load a new key, often referred to as “red key”, into the secure hardware device, the software object may be required to log in step 124. The log in method may include authenticating the software object using the certificate in step 126. Once the software object is authenticated in step 126, the secure hardware device may advance to the next crypto state and request a password in step 128 prior to allowing access to change the key. At this crypto state, the secure hardware device may request a signed message in step 130 from the software object prior to granting the software object access to change the secure hardware device configuration in step 134. Once the signed message is authenticated in step 132, the secure hardware device may grant access in step 134 to the internal key or to the encryption algorithm. Alternatively, the authenticity of the software object may be challenged whenever the software object requests to load data. Before allowing secure data to be loaded, the secure hardware device wants to trust the software object requesting the load.

While the tiered authentication method has been illustrated and described for use with a trusted software object, an authenticated commercial software object may be substituted. Likewise, although the tiered authentication method has been described for replacing a key within the secure hardware device, tiered authentication may be used for a variety of access requests, such as a request to change any protected data within the secure hardware device.

As to alternative embodiments, those skilled in the art will appreciate that the present secure hardware device authentication method may be implemented with alternative authentication techniques. While a certificate attached to a software object may be used to authenticate the software object, a signed message may be used or a combination of authentication methods may be combined. Likewise, while the present secure hardware device authentication method has been illustrated and described for use authenticating a software object prior to granting the software object access to the secure hardware device, alternatively the method may be used to authenticate the hardware executing the software object. The computer system into which the protected hardware device is installed and the trusted software object is executed, may be a cell phone, network device, digital set-top, handheld computing device or any other device requiring security as a part of the systems digital rights management system.

It is apparent that there has been described a secure hardware device authentication method that fully satisfies the objects, aims, and advantages set forth above. While the secure hardware device authentication method has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A method for preventing unauthorized access to data within a secure hardware device embedded in a computer system executing a trusted software object, the method comprising the steps of:
requesting access to said secure hardware device by said trusted software object;
authenticating a signature of said trusted software object;
authorizing access to said secure hardware device if said signature of said trusted software object is authenticated; and
denying access to said secure hardware device if said signature of said trusted software object is not authenticated.

2. The method of claim 1 wherein said authenticating comprises:
requesting a certificate from said trusted software object by said secure hardware device when said trusted software object requests access to said secure hardware device; and
verifying that said signature of said trusted software object matches a public key in said certificate, wherein if said signature matches said public key, said trusted software object is authenticated.

3. The method of claim 1 further comprising:
authenticating a signed message from said trusted software object to said secure hardware device.

4. The method of claim 3 wherein said authenticating a signed message comprises:
creating a message by said trusted software object;
signing said message created by said software object with said signature;
sending said signed message from said trusted software object to said secure hardware device;
verifying that said signature of said received signed message matches said public key in said certificate.

5. The method of claim 1 wherein said authorizing access comprises:
executing a cryptographic protocol to create a secure encrypted channel for exchanging said data between said trusted software object and said secure hardware device.

6. The method of information between said secure hardware device and said trusted software object;
enabling logic internal to said secure hardware device to provide access to said data within said secure hardware device; and
exchanging said data between said trusted software object and said secure hardware device through said secure encrypted channel utilizing said exchanged encryption information.

7. The method of claim 6 wherein if said signature is authenticated, said authorizing access comprises:
requesting a signed message from said trusted software object by said secure hardware device;
creating a message by said trusted software object;
attaching said signature and said certificate to said message by said trusted software object to produce said signed message;
verifying that said signature attached to said message matches said public key in said certificate, wherein if said signature matches said public key, said trusted software object is authenticated.

8. The method of claim 6 wherein the trusted software object is a commercial software object, the method comprising:
at said secure hardware device, authenticating said commercial software object, said authenticating comprising:
authenticating a signed certificate attached to said commercial software object; and
authenticating a combination of said commercial software object and an appended certificate using a key within said certificate.

9. A method for preventing unauthorized access to data within a protected device embedded in a computer system executing a trusted software object, the method comprising the steps of:
requesting access to said protected device by said trusted software object;
authenticating a signature of said trusted software object;
authorizing access to said protected device if said signature of said software object is authenticated; and
denying access to said protected device if said signature of said software object is not authenticated.

10. The method of claim 9 wherein said authenticating comprises:
requesting a certificate from said software object by said protected device when said trusted software object requests access to said protected device; and
verifying that said signature of said trusted software object matches a public key in said certificate, wherein if said signature matches said public key, said trusted software object is authenticated.

11. The method of claim 9 further comprising:
authenticating a signed message from said trusted software object to said protected device.

12. A secure hardware device authentication method for use on a computer system embodying a secure hardware device and a commercial software object, the method comprising:
signing a certificate associated with said commercial software object with a signature corresponding to said commercial software object;
appending said certificate to said commercial software object;
signing said commercial software object and appended certificate;
the secure hardware device, authenticating said signed commercial software object and appended certificate;
authenticating said certificate appended to said commercial software object if said commercial software object and appended certificate is authenticated;
authenticating said signature on said certificate; and
granting access to said secure hardware device is said signature of said commercial software object and appended certificate is authenticated and said signature on said certificate is authenticated.

13. A secure hardware device authentication method for use on a computer system embodying a secure hardware device and a trusted software object, the method comprising:
authenticating said trusted software object when said computer system is initialized;
requesting access to data within said secure hardware device by said trusted software object after said initialization;
requesting a certificate from said trusted software object by said secure hardware device when said trusted operating system requests access to said secure hardware device;
authenticating a signature of said operating system using a public key in said received certificate from said trusted operating system;
if said signature is authenticated,
sending a signed messaged from said trusted software object to said secure hardware device;
authenticating said signed message at said secure hardware device;
providing access to said data stored in said secure hardware device if said signed message is authenticated; and
denying access to said data stored in said secure hardware device if said signed message is not authenticated.
